(19) United States
(12) Patent Application Publication
(10) Pub. No.: US 2002/0049611 A1
(43) Pub. Date: Apr. 25, 2002

(54) Accounting system for packet communication

(76) Inventor: Kazunori Sato, Tokyo (JP)

Correspondence Address: Whitham, Curtis & Whitham, Reston International Center, Suite 900, 11800 Sunrise Valley Dr., Reston, VA, 20191, US

(21) Appl. No.: 09/981,913

(22) Filed: Oct. 19, 2001

(30) Foreign Application Priority Data
Oct. 23, 2000 (JP) 2000-322503

(51) Int. Cl. G06F 17/60

(52) U.S. Cl. 705/1

(57) ABSTRACT

An accounting system used for a wireless communication system in which a data transmitter transmits data to a data receiver through a network, includes (a) a data server storing therein data transmitted from the data transmitter, and (b) a calculator calculating a fee payable to communication between the data transmitter and the data receiver. When the data receiver receives data stored in the data server, if the data transmitter is a predetermined one, the calculator charges the data transmitter for communication between the data transmitter and the data receiver.

### BACKGROUND OF THE INVENTION

1. Field of the Invention

The invention relates to an accounting system and a method of settling accounts for charging a specific data transmitter for packet communication which data transmitter has been designated in advance.

2. Description of the Related Art

In packet communication, a fee for communication is determined in accordance with an amount of packets having been transmitted between a transmitter and a receiver. It is expected that packet communication is made widely and widely in both private use and business use.

In private communication, in general, a data receiver makes a contract with a communication provider, and is charged for each communication. Hence, a data transmitter is not charged for communication, However, when communication is made for business use, a data transmitter frequently desires that a data receiver is not charged for communication like a free-dial telephone. Though there is such need, there have not been suggested a system which selects a data transmitter or a data receiver to be charged for communication, in accordance with whether the communication is made in private use or business use.

For instance, Japanese Unexamined Patent Publication No. 9-114891 has suggested a data processor connected to a plurality of terminals and further to a plurality of servers through Internet, including a first memory storing accesses made by the terminals to the servers, a second memory storing a bank account prior to the accesses, a calculator for calculating a fee for the accesses, and means for charging the bank account for the thus calculated fee.

Japanese Unexamined Patent Publication No. 10-162058 has suggested a method of collecting data on Internet. When a user requests a data server to transmit toll data thereto, the data server introduces the user to make access to a fee-managing server. The data server receives an e-mail address from the data server, and informs a user identified by the e-mail address, that the fee-managing server will charge the user for the toll data. The user is introduced by the fee-managing server to make access to the data server.

Though the Publications present an accounting system used for network communication, the above-mentioned used is not satisfied by the Publications.

### SUMMARY OF TIHE INVENTION

In view of the above-mentioned need, it is an object of the present invention to provide an accounting system used for a wireless communication system which accounting system selects a data transmitter or a data receiver to be charged for communication, in accordance with a purpose of the communication.

In the present invention mentioned below, a data transmitter is charged for communication made between the data transmitter itself and a data receiver, and a party to be charged for communication between a data transmitter and a data receiver can be changed to the data transmitter from the data receiver.

In one aspect of the present invention, there is provided an accounting system used for a wireless communication system in which a data transmitter transmits data to a data receiver through a network, including (a) a data server storing therein data transmitted from the data transmitter, and (b) a calculator calculating a fee payable to communication between the data transmitter and the data receiver, wherein when the data receiver receives data stored in the data server, if the data transmitter is a predetermined one, the calculator charges the data transmitter for communication between the data transmitter and the data receiver.

For instance, the calculator charges the data receiver for the communication, if the data transmitter is not the predetermined one.

For instance, the communication is packet communication, and the fee is calculated by the calculator in accordance with packet counts.

The data may be comprised of an e-mail transmitted from the transmitter to the data receiver through the network.

For instance, the predetermined one is a person who has made an accounting contract in advance with a provider having the data server and the calculator.

It is preferable that when the data receiver receives data stored in the data server, the data server makes judgment as to whether the data transmitter is a predetermined one, and, if the data transmitter is the predetermined one, the data server informs the calculator that the data transmitter is the predetermined one, and of an amount of data having been transmitted to the data receiver from the data transmitter.

There is further provided an accounting system used for a wireless communication system in which a data transmitter transmits data to a data receiver through a network, including (a) a data server storing therein data transmitted from the data transmitter, and (b) a calculator calculating a fee payable to communication between the data transmitter and the data receiver, wherein when the data receiver receives data stored in the data server, if a specific code is attached to the data by the data transmitter, the calculator charges the data transmitter for transmitting the data to the data receiver.

It is preferable that the specific code is comprised of a ciphered code.

It is preferable that the specific code is provided to the data transmitter from the data server upon a request from the data transmitter.

It is preferable that the data server removes the specific code from the data, and transmits the data to the data receiver.

For instance, the calculator charges the data receiver for the data, if the specific code is not attached to the data.

There is still further provided an accounting system used for a wireless communication system in which a home-page presenter transmits data to a user through a network, including (a) a data server storing therein data transmitted from the home-page presenter, and (b) a calculator calculating a fee payable to communication between the home-page presenter and the user, wherein when the user makes access to a home-page on which the data stored in the data server is displayed, if the home-page presenter is a predetermined one, the calculator charges the home-page presenter for the access made by the user to the homepage.

For instance, the calculator charges the user for the access, if the home-page presenter is not the predetermined one.

It is preferable that when the user receives data stored in the data server, the data server makes judgment as to whether the home-page presenter is a predetermined one, and, if the home-page presenter is the predetermined one, the data server informs the calculator that the home-page presenter is the predetermined one, and of packet counts.

In another aspect of the present invention, there is provided a method of settling accounts in a wireless communication system in which a data transmitter transmits data to a data receiver through a network, including the steps of (a) calculating a fee payable to communication between the data transmitter and the data receiver, (b) checking whether the data transmitter is a predetermined one, and (c) charging the data transmitter for the communication, if the data transmitter is the predetermined one.

The method may further include the step of charging the data receiver for the communication, if the data transmitter is not the predetermined one.

It is preferable that the communication is packet communication, and the fee is calculated in the step (a) in accordance with packet counts.

The method may further include the step of (d) transmitting an e-mail transmitted from the transmitter to the data receiver through the network, the step (d) being to be carried out prior to the step (a).

It is preferable that the data transmitter is checked in the step (b) as to whether the data transmitter is a person who has made an accounting contract in advance with a provider having the data server and the calculator.

The method may further include the steps of (d) making judgment as to whether the data transmitter is a predetermined one, and (e) informing a fee calculator that the data transmitter is the predetermined one, and of an amount of data having been transmitted to the data receiver from the data transmitter, if the data transmitter is the predetermined one.

There is further provided a method of settling accounts in a wireless communication system in which a data transmitter transmits data to a data receiver through a network, including the steps of (a) calculating a fee payable to communication between the data transmitter and the data receiver, (b) checking whether a specific code is attached to data by the data transmitter, and (c) charging the data transmitter for the communication, if the specific code is attached to the data.

It is preferable that the specific code is comprised of a ciphered code.

The method may further include the steps of (d) making a request to a charger to assign the specific code to the data transmitter, the step (d) being to be carried out by the data transmitter, (e) assigning the specific code to the data transmitter in response to the request, the step (e) being to be carried out by the charger, and (f) applying the specific code to the data, the step being to be carried out by the data transmitter.

The method may further include the steps of (d) removing the specific code from the data, and (e) transmitting the data to the data receiver without the specific code,

The method may further include the step of charging the data receiver for the data, if the specific code is not attached to the data.

It is preferable that the data is comprised of ac e-mail transmitted from the data transmitter to the data receiver through the network.

There is still father provided a method used for a wireless communication system in which a home-page presenter makes communication with a user through a network, including the steps of (a) calculating a fee payable to communication between the home-page presenter and the user, (b) checking whether the home-page presenter is a predetermined one, and (c) charging the home-page presenter for the communication, if the home-page presenter is the predetermined one.

The method may further include the step of charging the user for the communication, if the home-page presenter is not the predetermined one.

It is preferable that the communication is packet communication, and the fee is calculated in the step (a) in accordance with an amount of data transmitted from the home-page presenter to the user.

It is preferable that the home-page presenter is checked in the step (b) as to whether the home-page presenter is a person who has made an accounting contract in advance with a provider having the data server and the calculator.

The method may further include the steps of (d) making judgement as to whether the home-page presenter is a predetermined one, and (e) informing a fee calculator that the home-page presenter is the predetermined one, and of an amount of data having been transmitted to the user from the home-page presenter, if the home-page presenter is the predetermined one.

The advantages obtained by the aforementioned present invention will be described hereinbelow.

In accordance with the present invention, a data server or a provider having a data server distinguishes private communication and business communication from each other, charges a data transmitter or a data receiver in accordance with whether the data transmitter is a predetermined one or whether a specific code is attached to data transmitted to a data receiver from a data transmitter.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram illustrating the accounting system in accordance with the first embodiment of the present invention.

FIG. 2 is a flow-chart showing steps to be carried out in the accounting system illustrated in FIG. 1.

FIG. 3 is a block diagram illustrating the accounting system m accordance with the second embodiment of the present invention.

FIG. 4 is a flow-chart showing steps to be carried out in the accounting system illustrated in FIG. 3.

FIG. 5 is a flow-chart showing steps to be carried out in the accounting system in accordance with the third embodiment of the present invention.

### DESCRIPTION OF THE PREFERRED EMBODIMENTS

Preferred embodiments in accordance with the present invention will be explained hereinbelow with reference to drawings.

[First Embodiment]

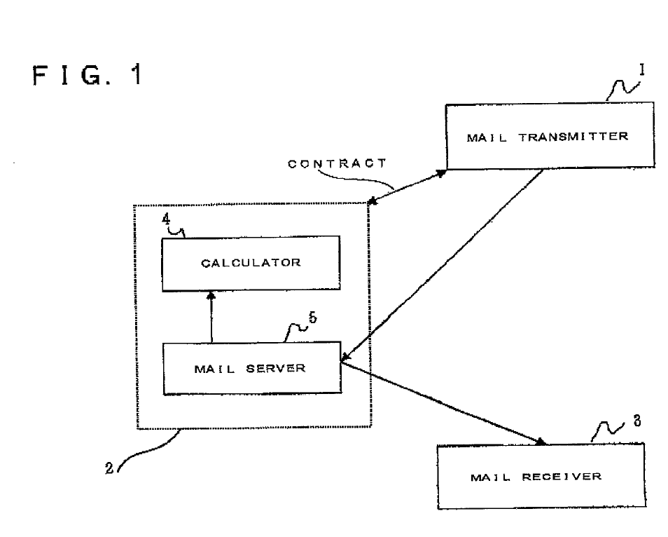

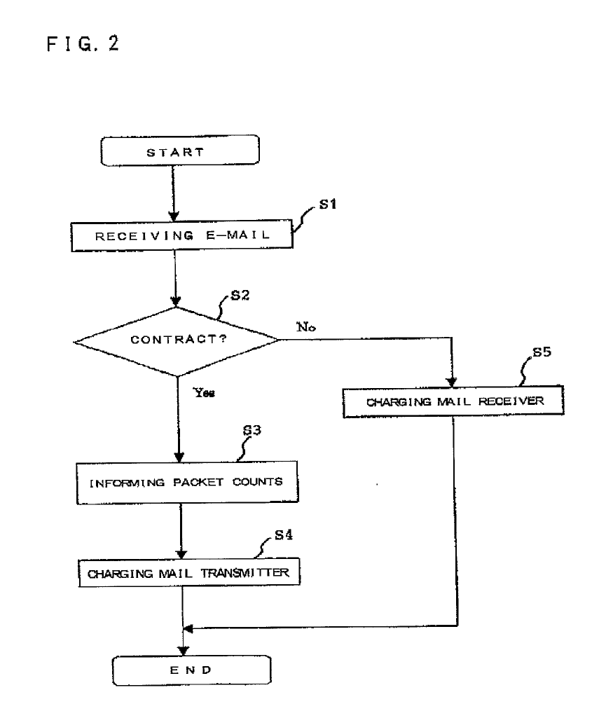

FIG. 1 is a block diagram illustrating the accounting system in accordance with the first embodiment, and FIG. 2 is a flow-chart showing steps to be carried out in the accounting system.

In the first embodiment, if a data transmitter makes an accounting contract with a provider, the data transmitter is charged for communication made between the data transmitter itself and a data receiver.

As illustrated in FIG. 1, the accounting system in accordance with the first embodiment is comprised of a mail transmitter 1, a communication provider 2, and a mail receiver 3. The communication provider 2 includes a calculator 4, and a mail server 5.

Hereinbelow is explained an operation of the accounting system in accordance with the first embodiment.

When the mail receiver 3 receives e-mails stored in the mail server 5 (step S1), the communication provider 2 checks whether the mail transmitter 1 makes an accounting contract with the communication provider 2 (step S2).

If the mail transmitter 2 has made an accounting contract with the communication provider 2 (Yes in step S2), the mail server 5 informs the calculator 4 that the mail transmitter 1 has an accounting contract with the communication provider 2, and further informs the calculator 4 of packet counts (step S3).

Though the mail receiver 8 is generally charged for communication made between the mail transmitter 1 and the mail receiver 3, the calculator 4 changes a party to be charged for the communication, to the mail transmitter 1 from the mail receiver 3 (step S4). if the mail transmitter 2 has not made an accounting contract with the communication provider 2 (No in step S2), the mail server 5 charges the mail receiver 3 for the communication as usual (step S5).

[Second Embodiment]

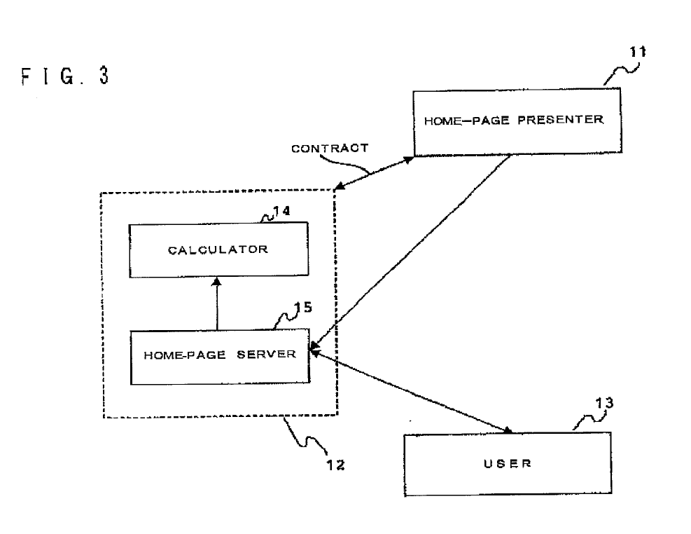

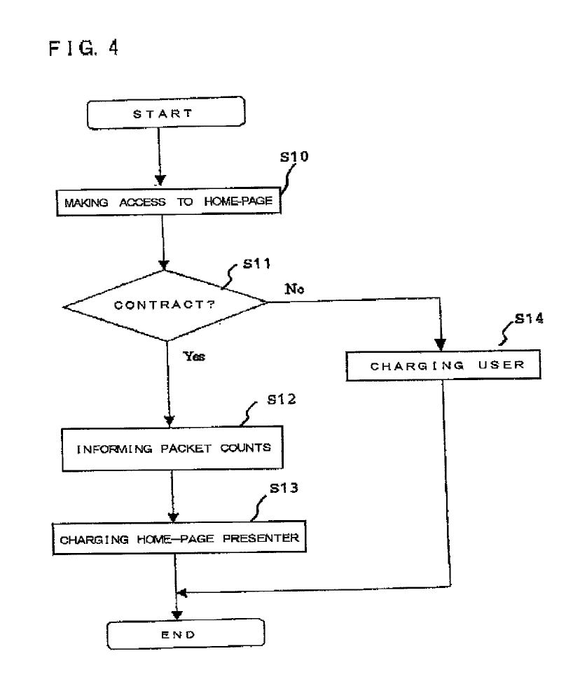

FIG. 3 is a block diagram illustrating the accounting system in accordance with the second embodiment, and FIG. 4 is a flow-chart showing steps to be carried out in the accounting system.

In the second embodiment, a home-page presenter is charged for a fee for many and unspecified persons to download data shown on a home-page presented by the home-page presenter.

As illustrated in FIG. 3, the accounting system in accordance with the second embodiment is comprised of a home-page presenter 11, a communication provider 12, and a user 13. The communication provider 12 includes a calculator 14, and a home-page server 15.

Hereinbelow is explained an operation of the accounting system in accordance with the second embodiment.

When the user 13 makes access to the home-page (step S10), the communication provider 12 checks whether the home-page presenter 11 makes an accounting contract with the communication provider 12 (step S11).

If the home-page presenter 11 has made an accounting contract with the communication provider 12 (Yes in step S11), the home-page server 15 informs the calculator 4 of an amount of data downloaded to the user 3 from the home-page, or packet counts (step S12).

Though the user 3 is generally charged for data having downloaded to the user 3 itself from the home-page, the calculator 14 changes a party to be charged for the communication, to the home-page presenter 11 from the user 5 (step S13).

If the home-page presenter 11 has not made an accounting contract with the communication provider 2 (No in step S11), the home-page server 15 charges the user 13 for the communication as usual (step S14).

[Third Embodiment]

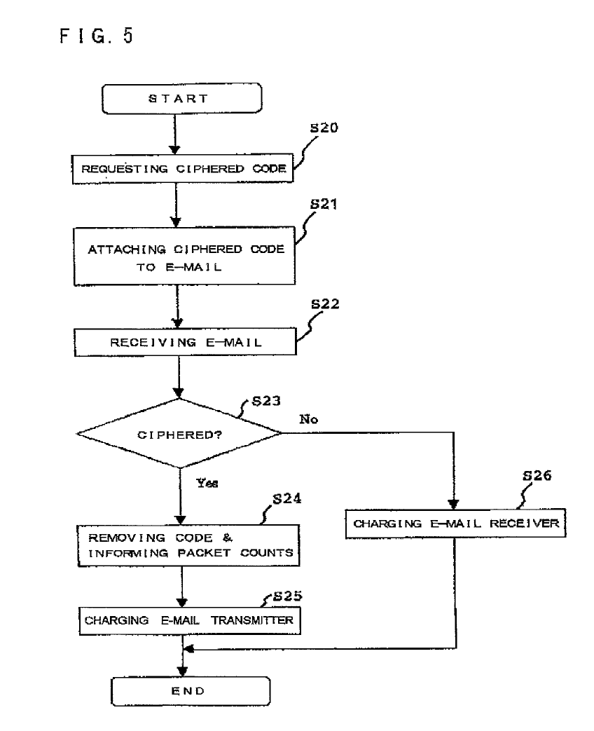

The accounting system in accordance with the third embodiment has the same structure as the structure of the accounting system in accordance with the first embodiment, illustrated in FIG. 1. FIG. 5 is a flow-chart showing steps to be carried out in the accounting system in accordance with the third embodiment.

In the third embodiment, if a predetermined specific code is attached to data, the data transmitter is charged for communication of the data, made between the data transmitter itself and a data receiver.

Hereinbelow is explained an operation of the accounting system in accordance with the third embodiments

When the mail transmitter 1 would like to use the accounting system, the mail transmitter 1 requests the communication provider 2 to provide a ciphered code thereto (step S20).

On receipt of the request from the mail transmitter 1, the mail server 5 transmits a ciphered code to the mail transmitter 1 (step S21).

When the mail receiver 3 receives e-mails stored in the mail server 5 (step S22), the communication provider 2 checks whether the ciphered code transmitted to the mail transmitter 1 from the mail server 5 is attached to the e-mails (step S23).

If the ciphered code is attached to the e-mails (Yes in step S23), the mail server 5 removes the ciphered code from the e-mails, and then, transmits the emails to the mail receiver 3, and currently, informs the calculator 4 of packet counts (step S24).

Though the mail receiver 3 is generally charged for communication made between the mail transmitter 1 and the mail receiver 3, the calculator 4 changes a party to be charged for the communication, to the mail transmitter 1 from the mail receiver 3 (step S25).

If the ciphered code is not attached to the e-mails (No in step S23), the mail server 5 charges the mail receiver 3 for the communication as usual (step S26).

While the present invention has been described in connection with certain preferred embodiments, it is to be understood that the subject matter encompassed by way of the present invention is not to be limited to those specific embodiments. On the contrary it is intended for the subject matter of the invention to include all alternatives, modifications and equivalents as can be included within the spirit and scope of the following claims.

The entire disclosure of Japanese Patent Application No. 2000-322503 filed on Oct. 23, 2000, 2000 including specification, claims, drawings and summary is incorporated herein by reference in its entirety.

What is clidmed is:

1. An accounting system used for a wireless communication system in which a data transmitter transmits data to a data receiver through a network, comprising:
(a) a data server storing therein data transmitted from said data transmitter; and
(b) a calculator calculating a fee payable to communication between said data transmitter and said data receiver,
wherein when said data receiver receives data stored in said data server, if said data transmitter is a predetermined one, said calculator charges said data transmitter for communication between said data transmitter and said data receiver.

2. The accounting system as set forth in claim 1, wherein said calculator charges said data receiver for said communication, if said data transmitter is not said predetermined one.

3. The accounting system as set forth in claim 1, wherein said communication is packet communication, and said fee is calculated by said calculator in accordance with packet counts.

4. The accounting system as set forth in claim 1, wherein said data is comprised of an e-mail transmitted from said transmitter to said data receiver through said network.

5. The accounting system as set forth in claim 1, wherein said predetermined one is a person who has made an accounting contract in advance with a provider having said data server and said calculator.

6. The accounting system as set forth in claim 1, wherein when said data receiver receives data stored in said data server, said data server makes judgment as to whether said data transmitter is a predetermined one, and, if said data transmitter is said predetermined one, said data server informs said calculator that said data transmitter is said predetermined one, and of an amount of data having been transmitted to said data receiver from said data transmitter.

7. An accounting system used for a wireless communication system in which a data transmitter transmits data to a data receiver through a network, comprising:
(a) a data server storing therein data transmitted from said data transmitter; and
(b) a calculator calculating a fee payable to communication between said data transmitter and said data receiver,
wherein when said data receiver receives data stored in said data server, if a specific code is attached to said data by said data transmitter, said calculator charges said data transmitter for transmitting said data to said data receiver.

8. The accounting system as set forth in claim 7, wherein said specific code is comprised of a ciphered code.

9. The accounting system as set forth in claim 7, wherein said specific code is provided to said data transmitter from said data server upon a request from said data transmitter.

10. The accounting system as set forth in claim 7, wherein said data server removes said specific code from said data, and transmits said data to said data receiver.

11. The accounting system as set forth in claim 7, wherein said calculator charges said data receiver for said data, if said specific, code is not attached to said data.

12. The accounting system as set forth in claim 7, wherein said communication is packet communication, and said fee is calculated by said calculator in accordance with packet counts.

13. The accounting system as set forth in claim 7, wherein said data is comprised of an e-mail transmitted from said data transmitter to said data receiver through said network.

14. An accounting system used for a wireless communication system in which a home-page presenter transmits data to a user through a network, comprising:
(a) a data server storing therein data transmitted from said home-page presenter; and
(b) a calculator calculating a fee payable to communication between said home-page presenter and said user,
wherein when said user makes access to a home-page on which said data stored in said data server is displayed, if said home-page presenter is a predetermined one, said calculator charges said home-page presenter for said access made by said user to said home-page.

15. The accounting system as set forth in claim 14, wherein said calculator charges said user for said access, if said home-page presenter is not said predetermined one.

16. The accounting system as set forth in claim 14, wherein said communication is packet communication, and said fee is calculated by said calculator in accordance with packet counts.

17. The accounting system as set forth in claim 14, wherein said predetermined one is a person who has made an accounting contract in advance with a provider having said data server and said calculator.

18. The accounting system as set forth in claim 14, wherein when said user receives data stored in said data server, said data server makes judgment as to whether said home-page presenter is a predetermined one, and, if said home-page presenter is said predetermined one, said data server informs said calculator that said home-page presenter is said predetermined one, and of an amount of data having been transmitted to said user from said home-page presenter.

19. A method of settling accounts in a wireless communication system in which a data transmitter transmits data to a data receiver through a network, comprising the steps of:
(a) calculating a fee payable to communication between said data transmitter and said data receiver;
(b) checking whether said data transmitter is a predetermined one; and
(c) charging said data transmitter for said communication, if said data transmitter is said predetermined one.

20. The method as set forth in claim 19, further comprising the step of charging sail data receiver for said communication, if said data transmitter is not said predetermined one.

21. The method as set forth in claim 19, wherein said communication is packet communication, and said fee is calculated in said step (a) in accordance with packet counts.

22. The method as set forth in claim 19, further comprising the step of (d) transmitting an e-mail transmitted from said transmitter to said data receiver through said network, said step (d) being to be carried out prior to said step (a).

23. The method as set forth in claim 19, wherein said data transmitter is checked in said step (b) as to whether said data transmitter is a person who has made an accounting contract in advance with a provider having said data server and said calculator.

24. The method as set forth in claim 19, further comprising the steps of:
(d) making judgment as to whether said data transmitter is a predetermined one; and
(e) informing a fee calculator that said data transmitter is said predetermined one, and of an amount of data having been transmitted to said data receiver from said data transmitter, if said data transmitter is said predetermined one.

25. A method of settling accounts in a wireless communication system in which a data transmitter transmits data to a data receiver through a network, comprising the steps of:
(a) calculating a fee payable to communication between said data transmitter and said data receiver;
(b) checking whether a specific code is attached to data by said data transmitter; and
(c) charging said data transmitter for said communication, if said specific code is attached to said data.

26. The method as set forth in claim 25, wherein said specific code is comprised of a ciphered code.

27. The method as set forth in claim 25, farther comprising the steps of:
(d) making a request to a charger to assign said specific code to said data transmitter, said step (d) being to be carried out by said data transmitter;
(e) assigning said specific code to said data transmitter in response to said request, said step (e) being to be carried out by said charger; and
(f) applying said specific code to said data, said step being to be carried out by said data transmitter.

28. The method as set forth in claim 25, further comprising the steps of:
(d) removing said specific code from said data, and
(e) transmitting said data to said data receiver without said specific code,

29. The method as set forth in claim 25, further comprising the step of charging said data receiver for said data, if said specific code is not attached to said data.

30. The method as set forth in claim 25, wherein said communication is packet communication, and said fee is calculated in said step (a) in accordance with packet counts.

31. The method as set forth in claim 25, wherein said data is comprised of an e-mail transmitted from said data transmitter to said data receiver through said network.

32. A method used for a wireless communication system in which a home-page presenter makes communication with a user through a network, comprising the steps of:
(a) calculating a fee payable to communication between said home-page presenter and said user;
(b) checking whether said home-page presenter is a predetermined one; and
(c) charging said home-page presenter for said communication, if said homepage presenter is said predetermined one.

33. The method as set forth in claim 32, further comprising the step of charging said user for said communication, if said home-page presenter is not said predetermined one.

34. The method as set forth in claim 32, wherein said communication is packet communication, and said fee is calculated in said step (a) in accordance with packet counts.

35. The method as set forth in claim 32, wherein said home-page presenter is checked in said step (b) as to whether said home-page presenter is a person who has made an accounting contract in advance with a provider having said data server and said calculator.

36. The method as set forth in claim 32, further comprising the steps of:
(d) making judgment as to whether said home-page presenter is a predetermined one; and
(e) informing a fee calculator that said home-page presenter is said predetermined one, and of an amount of data having been transmitted to said user from said home-page presenter, if said home-page presenter is said predetermined one.
